(19) United States
(12) Patent Application Publication
(10) Pub. No.: US 2015/0088625 A1
(43) Pub. Date: Mar. 26, 2015

(54) METHOD, AN APPARATUS AND A COMPUTER PROGRAM FOR PROMOTING THE APPARATUS

(71) Applicants: Antti Eronen, Tampere (FI); Sujeet Mate, Tampere (FI); Juha Ojanpera, Nokia (FI)

(72) Inventors: Antti Eronen, Tampere (FI); Sujeet Mate, Tampere (FI); Juha Ojanpera, Nokia (FI)

(73) Assignee: Nokia Corporation, Espoo (FI)

(21) Appl. No.: 14/371,679

(22) PCT Filed: Jan. 30, 2012
(86) PCT No.: PCT/FI2012/050082

§ 371 Date: Aug. 26, 2014

(51) Int. Cl. G06Q 30/02; G06K 9/00; G06F 17/30; G06Q 50/00

(52) U.S. Cl. CPC G06Q 30/0214; G06Q 50/01; G06K 9/00295; G06F 17/30256
USPC 705/14.16

(57) ABSTRACT

The invention concerns a method for promoting a device (105). In the method a promotion mode is enabled on the device (105) and a biometric identification of a user (110) of the device (105) is performed. After this, and based on the biometric identification, it is determined whether the user (110) is unknown whereby a reward procedure is performed on the device (105). The biometric identification may involve capturing an image (11) of the user (110) with a camera (107) associated with the device (105), and the device (105) may be owned by another user (100). The invention concerns also an apparatus and a computer program.

### TECHNICAL FIELD

The present invention relates to a method, an apparatus and a computer program for promoting the apparatus. The invention relates to a peer-to-peer promotion.

### BACKGROUND

Increasingly more new electronic devices—especially electronic communication devices—are entering on the market. This creates competition between different devices, between different operating systems and between different application/service providers. In order to gain a good marketing position, new ways for promoting the new technology need to be developed. Traditional advertising methods (ads, television/radio commercials) seem not to provide a similar kind of a sensation as passing advertising information by word of mouth between persons or within a social network. In addition, official marketing channels may not reach all the potential customers.

Some methods are known that encourage people to promote products they are using to other people by word of mouth (i.e. buzzing). This is very important especially when new products are introduced to market, because persons more likely try a product after having received a recommendation from a trusted person (e.g. a friend).

However, there is a need for a technical solution for promoting electronic devices which solution is based on the word of mouth promotion.

### SUMMARY

Now there has been invented a method and technical equipment implementing the method, for overcoming the above need. Various aspects of the invention include a method, an apparatus and a computer readable medium comprising a computer program stored therein, which are characterized by what is stated in the independent claims. Various embodiments of the invention are disclosed in the dependent claims.

According to a first aspect, a method comprises enabling a promotion mode on a device; performing a biometric identification of a user of the device; based on the biometric identification, determining whether the user is unknown and then performing a reward procedure on the device.

According to an embodiment, determining whether the user is unknown comprises comparing the user to already identified users.

According to an embodiment, the biometric identification comprises face recognition.

According to an embodiment, the face recognition comprises extracting at least one facial feature.

According to an embodiment, determining whether the user is unknown comprises comparing the at least one facial feature to a facial feature database.

According to an embodiment, determining whether the user is unknown comprises determining whether the minimal distance to any of the stored features in the facial feature database is above a predetermined threshold.

According to an embodiment, the reward procedure comprises providing a provision point for the device.

According to an embodiment, the method comprises performing logging of device actions.

According to an embodiment, the reward procedure comprises providing a provision point for the device when the number of device actions exceeds a predetermined threshold.

According to an embodiment, the method comprises determining a relation of the user to device's owner based on information obtainable from a social network.

According to an embodiment, the reward procedure comprises providing a provision point for the device when the user is a friend of device owner's friend.

According to an embodiment, the reward procedure comprises providing a provision point for the device, when the user is—according to the information obtainable from the social network—located in a different place than the user of the device.

According to an embodiment, the reward procedure comprises providing a provision point for the device, when the user—according to the information obtainable from the social network—owns a different device compared to the promoted device.

According to an embodiment, the reward procedure comprises transmitting information on the provision points to a server in order to receive a reward.

According to an embodiment, the reward is one of the following: an access to one or more digital media files, a credit in on or more web service account, a discount on at least one product on a web shop, a free short message or a free multimedia message.

According to an embodiment, the device action is one of the following: starting an application, pressing a button on the device, starting the camera, taking a picture, rendering a media file.

According to a second aspect an apparatus comprises a processor, memory including computer program code, the memory and the computer program code configured to, with the processor, cause the apparatus to perform at least the following: enabling a promotion mode; performing a biometric identification of a user of the apparatus; based on the biometric identification, determining whether the user is unknown and if so performing a reward procedure.

According to an embodiment, computer program code is further configured to, with the processor, cause the apparatus to compare the user to already identified users.

According to an embodiment, computer program code is further configured to, with the processor, cause the apparatus to use face recognition as the biometric identification.

According to an embodiment, computer program code is further configured to, with the processor, cause the apparatus to extract at least one facial feature for the face recognition.

According to an embodiment, computer program code is further configured to, with the processor, cause the apparatus to compare the at least one facial feature to a facial feature database.

According to an embodiment, computer program code is further configured to, with the processor, cause the apparatus to determine whether the minimal distance to any of the stored features in the facial feature database is above a predetermined threshold.

According to an embodiment, computer program code is further configured to, with the processor, cause the apparatus to provide a provision point for the device as the reward procedure.

According to an embodiment, computer program code is further configured to, with the processor, cause the apparatus to perform logging of device actions.

According to an embodiment, computer program code is further configured to, with the processor, cause the apparatus to provide—as the reward procedure—a provision point for the device when the number of device actions exceeds a predetermined threshold.

According to an embodiment, computer program code is further configured to, with the processor, cause the apparatus to determine a relation of the user to device's owner based on information obtainable from a social network.

According to an embodiment, computer program code is further configured to, with the processor, cause the apparatus to provide a provision point for the device when the user is a friend of device owner's friend.

According to an embodiment, computer program code is further configured to, with the processor, cause the apparatus to provide a provision point for the device, when the user is—according to the information obtainable from the social network—located in a different place than the user of the device.

According to an embodiment, computer program code is further configured to, with the processor, cause the apparatus to provide a provision point for the device, when the user—according to the information obtainable from the social network—owns a different device compared to the promoted device.

According to an embodiment, computer program code is further configured to, with the processor, cause the apparatus to transmit information on the provision points to a server in order to receive a reward.

According to an embodiment, the reward is one of the following: an access to one or more digital media files, a credit in on or more web service account, a discount on at least one product on a web shop, a free short message or a free multimedia message.

According to an embodiment, the device action is one of the following: starting an application, pressing a button on the device, starting the camera, taking a picture, rendering a media file.

According to a third aspect a computer program embodied on a non-transitory computer readable medium, wherein the computer program comprises instructions causing, when executed on at least one processor, at least one apparatus to: enable a promotion mode; perform a biometric identification of a user of the apparatus; based on the biometric identification, to determine whether the user is unknown and if so to perform a reward procedure.

According to a fourth aspect a computer program comprises instructions causing, when executed on at least one processor, at least one apparatus to: enable a promotion mode; perform a biometric identification of a user of the apparatus; based on the biometric identification, to determine whether the user is unknown and if so to perform a reward procedure.

According to a fifth aspect an apparatus comprises processing means, memory means including computer program code, the apparatus further comprising: processing means configured to enable a promotion mode; processing means configured to perform a biometric identification of a user of the apparatus; processing means configured to determine, based on the biometric identification, whether the user is unknown and if so the processing means are configured to perform a reward procedure.

According to a sixth aspect a method for promoting an electronic device comprises enabling a promotion mode on a device by a first user of the device; performing a biometric identification of another user of the device; based on the biometric identification, determining whether the other user is unknown whereby the method further comprises performing a reward procedure on the device for said first user.

### DESCRIPTION OF THE DRAWINGS

In the following, various embodiments of the invention will be described in more detail with reference to the appended drawings, in which

FIG. 1 shows a simplified example of the concept of the invention according to one embodiment;

FIG. 2 shows an embodiment of the invention;

FIG. 3 shows another embodiment of the invention;

FIG. 4 shows yet another embodiment of the invention;

FIG. 5 shows yet another embodiment of the invention;

FIG. 6 shows an embodiment of the electronic device.

### DETAILED DESCRIPTION OF THE EMBODIMENTS

The embodiments of the invention combine word of mouth marketing with a biometric identification solution in order to obtain a technical solution for managing the promotion. The embodiments of the invention are developed to reward and encourage users to promote electronic devices to other users such as their acquaintances and peers. In particular, the method comprises automatically detecting when a device is being promoted and rewarding the promoting user for doing so.

The electronic device can be an electronic communication device with a camera functionality, but also any other electronic device being capable of imaging. The electronic device may be a mobile device, a desktop computer, a laptop computer, a mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. The electronic device may incorporate the camera functionality or may be connected to an external device having the camera functionality (for example when the electronic device is a desktop computer being connected to a web camera). In addition to the camera functionality, the electronic device may comprise a face recognition algorithm and/or any other biometric identification algorithm, or may be connected to a device performing a face recognition and/or any other biometric identification.

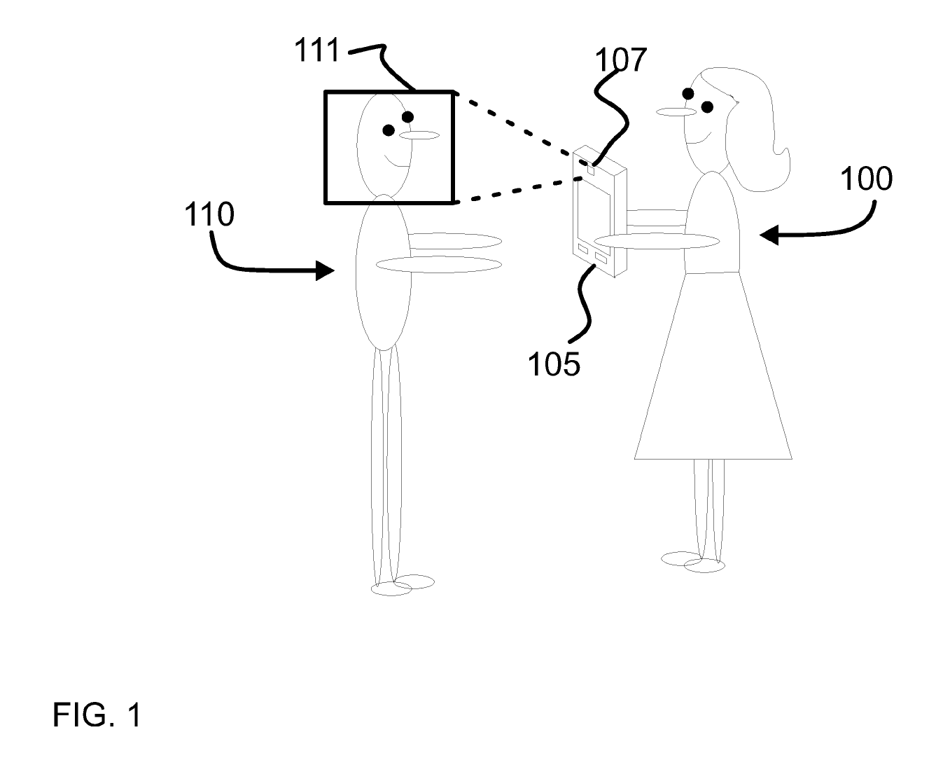

A concept of the invention is illustrated in FIG. 1 in a very simplified manner. When a user 100 (e.g. an owner) of the electronic device 105 shows the device 105 to another user 110, the camera 107 of the device 105 or an external camera is used to capture an image 111 of the other user 110 and used to biometrically detect and recognize the other user 110. The biometric identification can be compared to a history of already seen persons (friends). If the person has not been seen before, the user 10 of the device 105 is rewarded e.g. with promotion points.

In an embodiment, the biometric identification of the other user 110 may also be compared to the persons in the device owner's 100 social network. The promotion points may be differentiated based on the relation in the social network site. For example, more promotion points may be granted for promoting the device to persons who are connected by two hops (i.e. friend of a friend) compared to promoting the device directly to a friend. Also, different amount of promotion points may be given for promoting the device to connections that are in a different location compared to connections who are in the same city.

In another embodiment of the invention, if the mobile device information (or information concerning another electronic device being promoted) is available in the social network profile, yet different amount of promotion points may be granted when promoting the device to the connections who own a different device.

With the promotion points, the user may get a free short message, free multimedia message, a free music or video download, an access to one or more digital media files, a credit in one or more web service account, a discount on at least one product on a web shop for every person to which the electronic device is shown.

In another embodiment, the system may require that the new user tests the device functionality for a certain period of time (having face visible for the camera). In addition, buttons of the device may be pressed and applications may be started/stopped. Such functionality testing would provide more promotion points to the owner of the device as is described in the following.

An embodiment of the invention is described next. In this embodiment the electronic device is a mobile phone equipped with a camera and a face recognition algorithm. The face recognition algorithm can by any known face recognition algorithm. Face recognition algorithm may comprise steps for extracting a set of facial features from the captured image and for comparing the features against a facial database containing the same set of features extracted from a population of users. If a match is found from the facial database, the user is recognized. A match can be declared, for example, when the distance (e.g. Euclidean distance) between the facial features extracted from the image and one of the subjects in the facial database is below a predetermined threshold.

After having a new device, a user (i.e. an owner) of the device can enable the promotion functionality. The enabling can be performed e.g. by using a dedicated motion (a gesture) which would be detected using the device's accelerometer signal. Another possibility is to use an interface interaction, such as clicking a button or interacting with the touch/voice user interface to enable the mode.

When the functionality is enabled, the system may take a picture of the user (i.e. the owner of the device) by using the front camera of the device, and initialize the facial feature database with features extracted from the image of the user. Thus, the owner of the device is the first person in the facial image database.

After this, the user may start using the promotion system for promotion. When the user sees a friend (i.e. another user) to whom s/he wants to promote the device, s/he enables the promotion mode and hands the phone to the friend. FIG. 1 illustrates this phase in a simplified manner. The front camera takes a picture of the other user and determines whether the other user is a new face or already known. The other user may fiddle around with the phone, press some buttons and start and stop applications, test the camera, music player and various other functionalities of the phone. After the other user has tested the device enough, the owner of the device may be granted promotion points according to following embodiments.

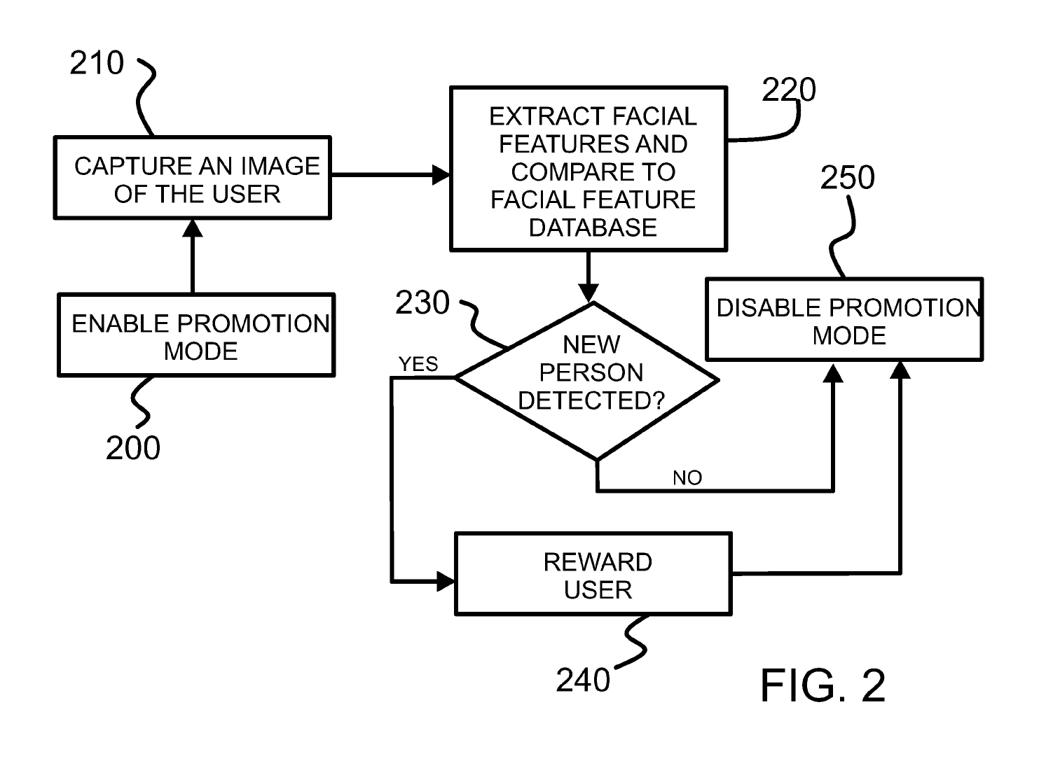

FIG. 2 illustrates an embodiment of the system operations as a flowchart. Upon starting of the promotion mode (200), the device is handed to another user and the promotion software of the device enables at least the front camera. The promotion software captures (210) an image of the other user with the front camera, extracts facial features from the image and compares the facial features to the facial database (220). If a match is not found, the system declares that a new person has been identified (230), and adds the facial features of the other user to the database. A match is not found, if none of the facial features in the facial feature database are close enough to the features being extracted from the image being captured on the other user. For example, there may be a threshold for the distance between facial features below which a match is detected and above which a match is not detected.

In this embodiment (FIG. 2) not finding a match is the only criterion for a successful promotion event. This is because, the promotion should happen to a new person who has not yet been promoted to. When a new person is detected, the owner of the device is rewarded (240). If it is determined that the person is already known, the method proceeds to step where the promotion mode is stopped (250). It is also possible that the method continues from step 210 in order to capture an image of another target of the promotion (i.e. yet another user). Similarly, after having rewarded the owner of the device, the method may proceed to step 250, or optionally to step 210.

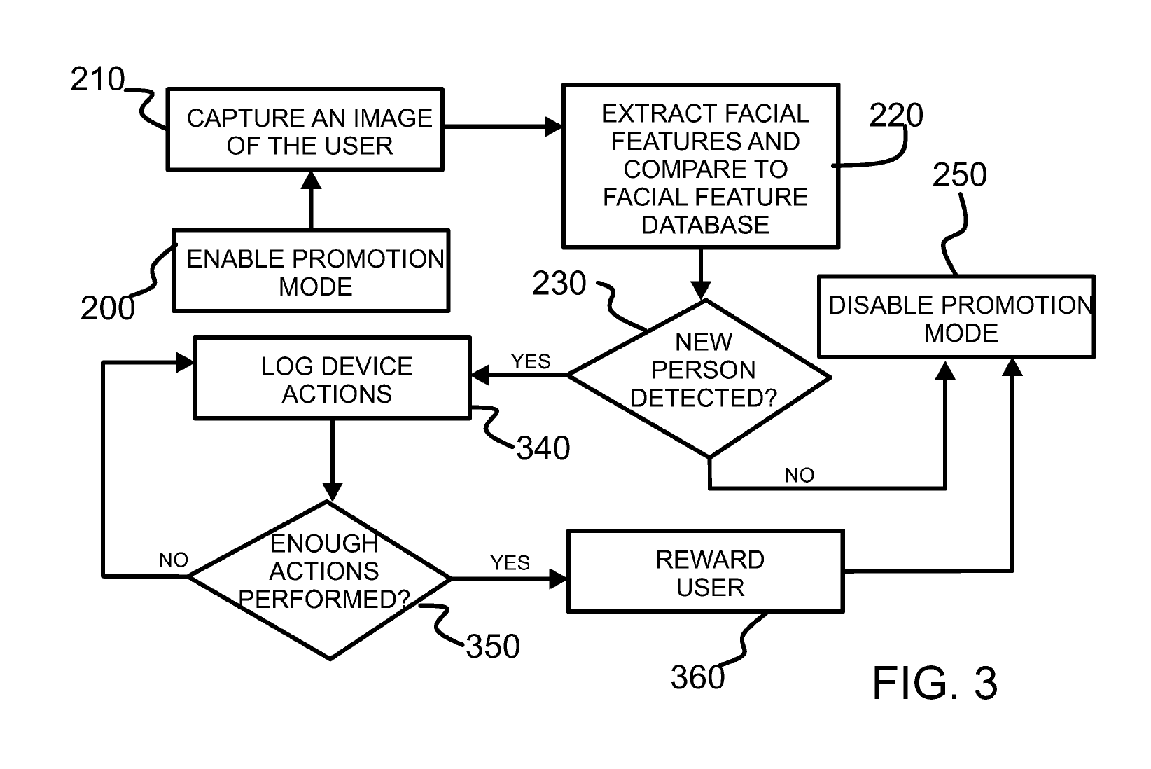

FIG. 3 illustrates another embodiment of the system operations. Upon starting of the promotion mode (200), the device is handed to another user and the promotion software of the device enables the front camera and a device action logging module. The procedure proceeds according to FIG. 2 to the step, where a new person is detected (230). If the person is new, the device action logging module starts logging device actions (340). This means that any action that the other user is performing with the device is written to the log. In this embodiment (FIG. 3) the first criterion for successful promotion is a new person (i.e. not finding a match in a facial feature database) on step 230 and the second criterion is that the other user must test some of the phone functionalities. For this purpose, the activity logging module logs the application starting and stopping events (340). When a predetermined amount of actions on the phone has been performed (350), for example, five different applications have been started and used for a while; the criterion for successful promotion is met and the owner of the device may be rewarded (360). Also in this example, the process may be stopped after having rewarded the user or if the other user was already known. Instead of stopping the process, the method may proceed to step 210 in order to capture an image of yet another user.

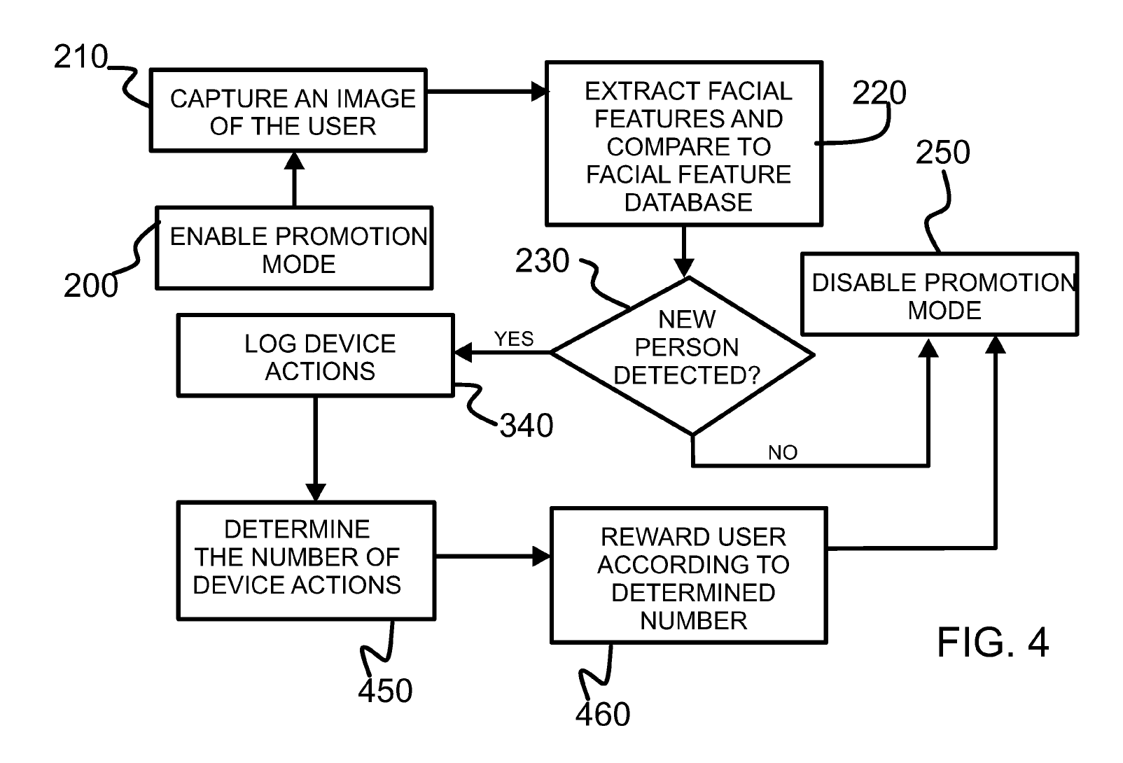

FIG. 4 illustrates yet another embodiment of the system operations. Upon starting of the promotion mode (200), the device is handed to another user and the promotion software of the device enables the front camera and a device action logging module. The procedure proceeds according to FIG. 3 to the step, where the device action logging module starts log device actions (340). Instead of determining whether enough actions are performed, in this embodiment (FIG. 4) the system basically determines the number of device actions (450). The reward is dependent on the number of actions, whereby the owner of the device is rewarded according to the determined number (460). The more device actions is being performed, the more valuable the reward can be and more promotion points are granted. Also in this example, the process may be stopped after having rewarded the user or if the other user was already known in step 230. Instead of stopping the process, the method may proceed to step 210 in order to capture an image of yet another user.

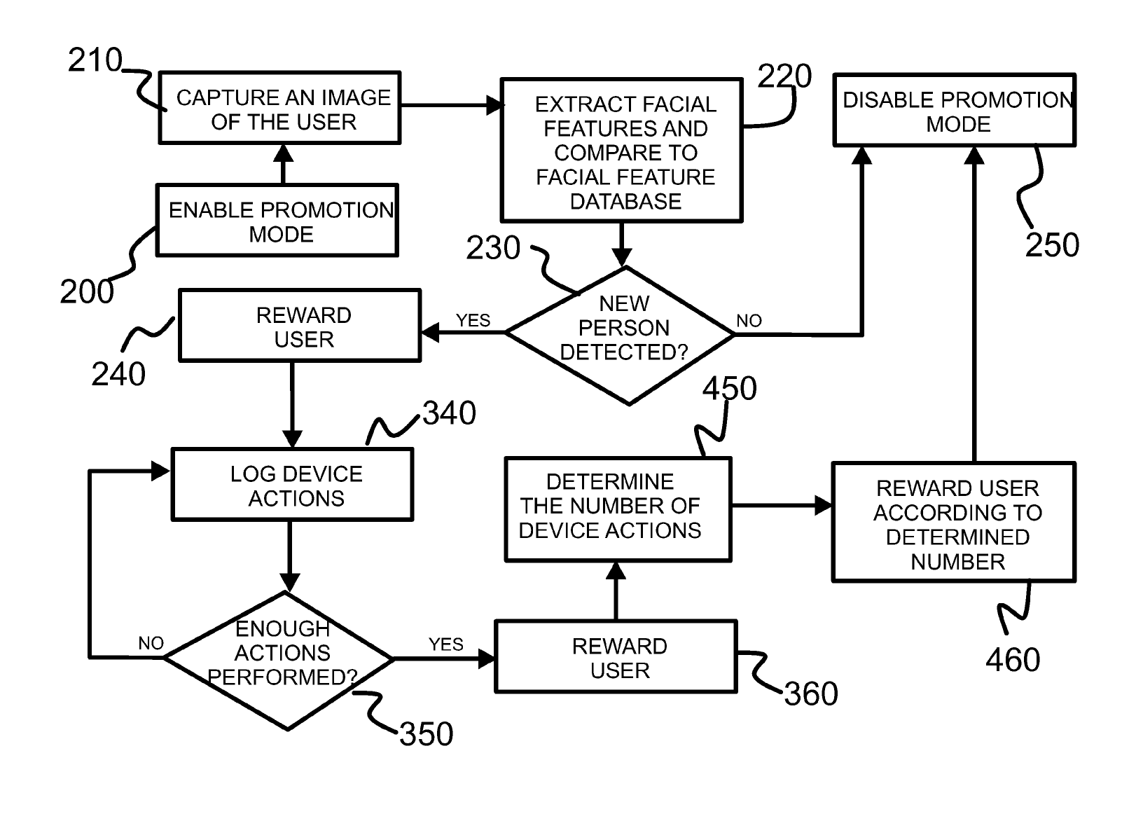

FIG. 5 illustrates yet another embodiment of the system operations. Embodiment of FIG. 5 combines the embodiments of FIGS. 2-4. Upon starting of the promotion mode (200), the device is handed to another user and the promotion software of the device enables the front camera and a device action logging module. The promotion software captures (210) an image with the front camera, extracts facial features from the image and compares the facial features to the facial database (220). If a match is not found, the system declares that a new person has been identified (230), and adds the facial features being extracted from the image taken from the other user in to the database. In this embodiment (FIG. 5) not finding a match is the first step in the promotion event and the user is rewarded for this (240). After this, the device action logging module starts log device actions (340). This means that any action that the other user is performing with the device is written to the log. Therefore the second step in the promotion event is that the other user tests some of the device's functionalities. When a predetermined amount of actions on the phone has been performed (350), the owner of the device is—again—rewarded (360). The process continues to step, where the number of device actions are determined (450). Therefore the third step in the promotion event is that the other user continues testing the device even more than was required, whereby the owner of the device can be rewarded (460) according to the actions being performed by the other user. In this embodiment, the owner of the device has three possibilities for gaining promotion points, and thus to increase the final amount of promotion points.

In the above embodiments, after successful promotion, the owner of the device is rewarded with promotion points. As a reward, and depending on the amount of promotion points, the owner of the device may get, for example, an access to one or more digital media files, a credit in on or more web service account, a discount on at least one product on a web shop, a free short message or a free multimedia message or some other suitable award. Instead of earning promotion points as such, the owner of the device may be given a free short message or any other of the above examples directly. This means that for a new person as a target of the promotion, the user may be given a free short message, for e.g. three actions being performed by the new user the owner of the device may be given an access to a music file etc. In addition music advertisement and other files pre-stored on the device can be unlocked by showing the device to a new person. The user may take the phone to a new person and let her/him hear some of the locked songs once. Further listening requires purchasing a license.

The reward procedure may be implemented on a second physical device (e.g. a service, a server). This means that provision points are gathered in the promoted device, which promotion points (or an information concerning the promotion points) are transmitted to the server (or service) in order to receive the reward. The promoted device may trigger the rewarding, for example, by sending a message to the server (or service) that a reward can be granted to the user of the device. The reward can be a code to be used in a web service for above mentioned service or an increase in user's subscription account at the operator.

In the above embodiments, the promotion application may continue to capture facial images of the other user until the predetermined number of actions has been performed in order to ensure that the other user actually is the one using the device. This is to ensure that the user is not switched in between, for example, back to the owner of the device.

If another new face is detected while action logging is still ongoing, the device may notify the users that the promotion is still ongoing, and query whether they want to continue with the user that was already using the device or start again with a new user.

Facial images or features may not be communicated outside the device. The device stores features of already seen faces in encrypted format. The comparison of facial features happens in the device. When a new device is purchased, the facial features shall not be copied from the previous device, because an embodiment of the invention aims to encourage promoting the new device also and therefore to restart the whole process.

In the above embodiments of the invention, the electronic device being promoted is a mobile terminal. However, as said, the electronic device may by some other device also. For example, the electronic device can a laptop computer equipped with a web camera and a face recognition algorithm. In addition, the identification of the other user may be based on some other biometric identification instead of face recognition. For example, the other user may be identified by finger print or a voice print, wherein the face recognition algorithm in above embodiments is replaced either with finger print recognition algorithm or a voice recognition algorithm. Similarly, the facial feature database should be replaced with a database of fingerprints or voice prints respectively. Other forms of biometric identification known in the art could also be used, including but not limited to palm print recognition, hand geometry recognition, iris recognition, odour/scent recognition, typing rhythm recognition, or gait recognition. The basic principle of recognition can be similar to face recognition also in these cases, the recognition comprising receiving data from a sensor, such as camera, microphone, accelerometer, or a dedicated fingerprint sensor, for example, extracting at least one feature from the data, comparing the extracted feature against features of known persons, and determining whether the person is known or unknown. For example, in the case of voice recognition, the input sensor is the microphone. The features to be extracted can be mel-frequency cepstral coefficients, and the speaker voice models can be, for example, Gaussian mixture models. When the new user uses the device in the promotion mode and voice recognition is used, the user needs to utter a free text sentence or a predetermined word, during which the system extracts a sequence of mel-frequency cepstral coefficient feature vectors. These extracted features are then compared against the stored speaker models to determine whether the user is already known or whether he/she is a new user. The user may be determined known if some of the stored Gaussian mixture speaker models give a high enough likelihood for the user, and unknown if none of the speaker models give a high enough likelihood. The biometric recognition algorithm being used may thus vary as long as it produces a trustworthy identification of the user.

The various embodiments of the invention can be implemented with the help of computer program code that resides in a memory and causes the relevant apparatuses to carry out the invention. For example, an electronic device may comprise circuitry and electronics for handling, receiving and transmitting data, computer program code in a memory, and a processor that, when running the computer program code, causes the electronic device to carry out the features of an embodiment. Yet further, the electronic device may be connected over a network to a network device comprising circuitry and electronics for handling, receiving and transmitting data, computer program code in a memory, and a processor that, when running the computer program code.

The network may comprise a wireless network (e.g., a cellular network, wireless local area network, wireless personal area network, wireless metropolitan area network, and/or the like), a wireline network, or some combination thereof, and in some embodiments comprises at least a portion of the internet. As said, the electronic device may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. In this regard, the electronic device may be embodied as any computing device having a imaging capability and some kind of a biometric identification algorithm.

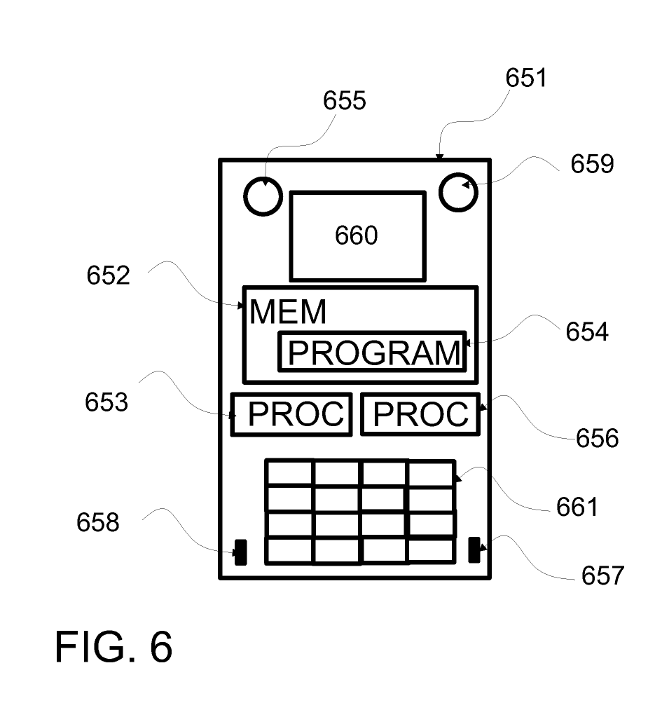

An example of the electronic device is shown in FIG. 6. A mobile terminal 651 representing an example of the electronic device, contains memory 652, at least one processor 653 and 656, and computer program code 654 residing in the memory 652. The device may also have one or more cameras 655 and 659 for capturing image data. The device may also contain one, two or more microphones 657 and 658 for capturing sound. The device may also comprise a display 660. The device 651 may also comprise an interface means (e.g., a user Interface) which may allow a user to interact with the device. The user interface means may be implemented using a display 660, a keypad 661, voice control, gesture recognition or other structures. The device may also be connected to another device e.g. by means of a communication block (not shown in FIG. 6) able to receive and/or transmit information. For example, the apparatus may comprise a short-range radio frequency (RF) transceiver and/or interrogator so data may be shared with and/or obtained from electronic devices in accordance with RF techniques. The apparatus may comprise other short-range transceivers, such as, for example, an infrared (IR) transceiver, a Bluetooth™ (BT) transceiver operating using Bluetooth™ brand wireless technology developed by the Bluetooth™ Special Interest Group, a wireless universal serial bus (USB) transceiver and/or the like. The Bluetooth™ transceiver may be capable of operating according to ultra-low power Bluetooth™ technology (for example, Wibree™) radio standards. In this regard, the device and, in particular, the short-range transceiver may be capable of transmitting data to and/or receiving data from electronic devices within a proximity of the apparatus, such as within 10 meters, for example. Although not shown, the device may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like. Although not shown, the device may comprise a battery for powering various circuits related to the device, for example, a circuit to provide mechanical vibration as a detectable output. In addition, the device may comprise circuitry and electronics for handling, receiving and transmitting data, computer program code in a memory, and a processor that, when running the computer program code, causes the apparatus to carry out the features of an embodiment.

The one or more processors 653, 656 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. These signals sent and received by the processor 653, 656 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the device may be capable of operating with one or more air interface standards, communication protocols, modulation types, access types, and/or the like. More particularly, the device may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the apparatus may be capable of operating in accordance with 2G wireless communication protocols IS-136 (Time Division Multiple Access (TDMA)), Global System for Mobile communications (GSM), IS-95 (Code Division Multiple Access (CDMA)), and/or the like.

Also, for example, the apparatus may be capable of operating in accordance with 2.5G wireless communication protocols General Packet Radio Service (GPRS), Enhanced Data GSM Environment (EDGE), and/or the like. Further, for example, the apparatus may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus may be additionally capable of operating in accordance with 3.9G wireless communication protocols such as Long Term Evolution (LTE) or Evolved Universal Terrestrial Radio Access Network (E-UTRAN) and/or the like. Additionally, for example, the apparatus may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), apparatuses may also benefit from embodiments of this invention, as should dual or higher mode phones (for example, digital/analog or TDMA/CDMA/analog phones). Additionally, the device 651 may be capable of operating according to Wireless Fidelity (Wi-Fi) or Worldwide Interoperability for Microwave Access (WiMAX) protocols.

It is understood that the processor 653, 656 may comprise circuitry for implementing audio/video and logic functions of the apparatus 651. For example, the processor 653, 656 may comprise a digital signal processor device, a microprocessor device, an analog-to-digital converter, a digital-to-analog converter, and/or the like. Control and signal processing functions of the apparatus may be allocated between these devices according to their respective capabilities. The processor may additionally comprise an internal voice coder, an internal data modem, and/or the like. Further, the processor may comprise functionality to operate one or more software programs, which may be stored in memory 652. For example, the processor 653, 656 may be capable of operating a connectivity program, such as a web browser. The connectivity program may allow the apparatus 651 to transmit and receive web content according to a protocol, such as Wireless Application Protocol (WAP), hypertext transfer protocol (HTTP), and/or the like. The device 651 may be capable of using a Transmission Control Protocol/Internet Protocol (TCP/IP) to transmit and receive web content across the internet or other networks.

In addition, the device 651 in some embodiments includes positioning circuitry (not shown). The positioning circuitry may include, for example, a GPS sensor, an assisted global positioning system (Assisted-GPS) sensor, a Bluetooth (BT)-GPS mouse, other GPS or positioning receivers, or the like. However, in one exemplary embodiment, the positioning circuitry may include an accelerometer, pedometer, or other inertial sensor. In this regard, the positioning circuitry may be capable of determining a location of the device 651, such as, for example, longitudinal and latitudinal directions of the device 651, or a position relative to a reference point such as a destination or start point. Further, the positioning circuitry may determine the location of the device 651 based upon signal triangulation or other mechanisms. Information from the positioning sensor may then be communicated to a memory of the device 651 or to another memory device to be stored as a position history or location

In an embodiment, the processing means are configured to enable a promotion mode on a device, to perform a biometric identification of a user of the device, based on the biometric identification, to determine whether the user is unknown and to perform a reward procedure on a device.

The present solution for device-centred promotion represents a substantial advancement in this field of technology. It is obvious that the present invention is not limited solely to the above-presented embodiments, but it can be modified within the scope of the appended claims.

1-36. (canceled)

37. A method comprising:
enabling a promotion mode on a device,
performing a biometric identification of a user of the device,
based on the biometric identification, determining whether the user is unknown whereby the method further comprises
performing a reward procedure on the device.

38. The method of claim 37, wherein the reward procedure comprises providing a provision point for the device.

39. The method of claim 37, further comprising determining a relation of the user to device's owner based on information obtainable from a social network.

40. The method of claim 39, wherein the reward procedure comprises providing a provision point for the device when the user is a friend of device owner's friend.

41. An apparatus comprising a processor, memory including computer program code, the memory and the computer program code configured to, with the processor, cause the apparatus to perform at least the following:
enable a promotion mode,
perform a biometric identification of a user of the apparatus,
based on the biometric identification, determine whether the user is unknown and if so
perform a reward procedure.

42. The apparatus of claim 41, further comprising computer program code configured to, with the processor, cause the apparatus to perform at least the following:
compare the user to already identified users.

43. The apparatus of claim 41, further comprising computer program code configured to, with the processor, cause the apparatus to perform at least the following:
use face recognition as the biometric identification.

44. The apparatus of claim 43, further comprising computer program code configured to, with the processor, cause the apparatus to perform at least the following:
extract at least one facial feature for the face recognition.

45. The apparatus of claim 44, further comprising computer program code configured to, with the processor, cause the apparatus to perform at least the following:
compare the at least one facial feature to a facial feature database.

46. The apparatus of claim 45, further comprising computer program code configured to, with the processor, cause the apparatus to perform at least the following:
determine whether the minimal distance to any of the stored features in the facial feature database is above a predetermined threshold.

47. The apparatus of claim 41 further comprising computer program code configured to, with the processor, cause the apparatus to perform at least the following:
provide a provision point for the device as the reward procedure.

48. The apparatus of claim 41 further comprising computer program code configured to, with the processor, cause the apparatus to perform at least the following:
perform logging of device actions.

49. The apparatus of claim 48, further comprising computer program code configured to, with the processor, cause the apparatus to perform at least the following:
provide—as the reward procedure—a provision point for the device when the number of device actions exceeds a predetermined threshold.

50. The apparatus of claim 41, further comprising computer program code configured to, with the processor, cause the apparatus to perform at least the following:
determine a relation of the user to device's owner based on information obtainable from a social network.

51. The apparatus of claim 50, further comprising computer program code configured to, with the processor, cause the apparatus to perform at least the following:
provide a provision point for the device when the user is a friend of device owner's friend.

52. The apparatus of claim 50, further comprising computer program code configured to, with the processor, cause the apparatus to perform at least the following:
provide a provision point for the device, when the user is—according to the information obtainable from the social network—located in a different place than the user of the device.

53. The apparatus of claim 50, further comprising computer program code configured to, with the processor, cause the apparatus to perform at least the following:
provide a provision point for the device, when the user—according to the information obtainable from the social network—owns a different device compared to the promoted device.

54. The apparatus of claim 47, further comprising computer program code configured to, with the processor, cause the apparatus to perform at least the following:
transmit information on the provision points to a server in order to receive a reward.

55. The apparatus of claim 54 wherein the reward is one of the following: an access to one or more digital media files, a credit in on or more web service account, a discount on at least one product on a web shop, a free short message or a free multimedia message.

56. The apparatus of claim 48 wherein the device action is one of the following: start an application, press a button on the device, start the camera, take a picture, listen a music file.
